(19) United States
(12) Patent Application Publication
(10) Pub. No.: US 2025/0087931 A1
(43) Pub. Date: Mar. 13, 2025

(54) MODULAR HOUSING ARRANGEMENT AND ELECTRICAL CONNECTOR

(71) Applicant: TE Connectivity Solutions GmbH, Schaffhausen (CH)

(72) Inventors: Michael SCHALL, Bensheim (DE); Andreas WILKNER, Bensheim (DE)

(21) Appl. No.: 18/825,901

(22) Filed: Sep. 5, 2024

(30) Foreign Application Priority Data
Sep. 8, 2023 (DE) 102023124314.4

(51) Int. Cl. H01R 13/514; H01H 85/20

(52) U.S. Cl. CPC H01R 13/514; H01H 85/205; H01H 2085/209

(57) ABSTRACT

A modular housing assembly for an electrical connector connectable to a plug fuse includes a surrounding housing and an inner housing that receives a contact element plugged to the plug fuse and has an insertion opening through which one of the fuse contacts of the plug fuse can be plugged. The surrounding housing includes a module chamber receiving the inner housing and an access opening leading into the module chamber that passes through a housing wall and is sized to receive the fuse body of the plug fuse along the material thickness of the housing wall. The fuse contact coming from outside can better reach the internally disposed contact element. An electrical connector is provided with such a housing assembly and a contact element.

### CROSS REFERENCE TO RELATED APPLICATIONS

This application claims the benefit of DE Application No. 102023124314.4, filed 08-Sep.-2023, the subject matter of which is herein incorporated by reference in its entirety.

### BACKGROUND OF THE INVENTION

The subject matter herein relates to a housing arrangement for an electrical connector which is connectable to a plug fuse. The subject matter herein further relates to an electrical connector with such a housing assembly.

In many fields of technology, circuits must be protected by way of an electrical fuse against faulty currents and/or overcurrents. An electrical connector can be employed to detachably connect the respective circuit to an associated fuse. Accordingly, it is advisable to use a so-called plug fuse which comprises pluggable fuse contacts that can be contacted with contact elements of the circuit.

The electrical connector can then be plugged into a fuse box, for example, in which one or more plug fuses are provided. The contacting mentioned above integrates the plug fuse into the circuit in an electrically conductive manner. Reliable contacting is therefore paramount.

Depending on the application, the plug fuses can be present in different numbers and at different positions in the fuse box. Furthermore, although plug fuses are typically standardized components, there are size differences due to application-specific configurations. This means that a wide variety of combinations of plug fuses can arise in fuse boxes. The connectors are often prefabricated to match.

In particular with a high level of system complexity, the attempt to cover all “plug fuse models” with suitable connectors leads to an almost endless product portfolio and is associated with immense configuration, delivery, and storage costs. Furthermore, a new connector might then have to be procured every time the system is converted.

There is therefore a need for a connector that can be adapted to fuse boxes with different plug fuse configurations.

### BRIEF DESCRIPTION OF THE INVENTION

Various embodiments disclosed herein have an object of improving connectors in terms of their reliability and flexibility of use for connecting a circuit to a plug fuse.

This object may be satisfied by a modular housing assembly for an electrical connector which is connectable to a plug fuse of a predefined size with fuse contacts protruding from an abutment surface of a fuse body. The housing assembly comprises a surrounding housing and an inner housing, wherein the inner housing is configured to receive a contact element which can be connected to the plug fuse, wherein the inner housing comprises an insertion opening through which one of the fuse contacts of the plug fuse can be plugged, wherein the surrounding housing comprises a module chamber in which the inner housing can be arranged and an access opening leading into the module chamber, wherein the access opening passes through a housing wall of the surrounding housing and is sized such that the fuse body of the plug fuse can be inserted completely into the access opening along the material thickness of the housing wall.

The size of the plug fuse can be defined by its dimension or its external size, respectively. The housing wall can be an outer wall, in particular a base wall or side wall of the surrounding housing. Complete insertion is given when the fuse body enters the access opening over the entire extension length of the material thickness of the housing wall.

On the one hand, the subject matter herein is advantageous because the housing assembly can be flexibly adapted to the respective case of application due to its modular structure consisting of a surrounding housing and a separate inner housing. The inner housing can therefore be selected to suit the case of application or be easily exchanged during assembly or repair of the connector. This would not be possible with a single housing.

On the other hand, the subject matter herein is advantageous because the access opening is configured to receive at least in part the fuse body of the plug fuse. Without such an access opening, the plugged fuse contact would have to completely penetrate a double wall consisting of the surrounding housing and inner housing before it reaches the contact element. This would mean that the fuse contact coming from the outside would not reach the inner contact element sufficiently far, especially since plug fuses are typically standardized, as already mentioned, and the fuse contacts therefore cannot simply be extended.

By receiving the fuse body in the access opening along the entire material thickness of the housing wall of the surrounding housing, the plug fuse can be pushed deeper into the housing assembly. Consequently, only one individual wall of the inner housing needs to be penetrated. This enables the plugged fuse contact to better reach the contact element. In particular, the contact overlap between the fuse contact and the contact element can be increased, which ensures reliable contacting.

In another aspect, an electrical connector is provided with a housing assembly as disclosed above and a contact element also satisfies the object defined at the outset. The contact element there comprises a contact surface for electrically contacting the plug fuse, wherein the contact surface is arranged in the inner housing and is accessible to one of the fuse contacts of the plug fuse through the insertion opening of the inner housing.

Such a connector can be part of a circuit to be protected and benefits from the advantages of the housing assembly. By arranging the contact surface in the inner housing, these advantages come into play when the electrical connector is used in a fuse device which, in addition to the connector, comprises a plug fuse and a fuse box. The fuse box can be a fuse block, panel, and/or holder. The plug fuse is positioned in the fuse box in such a way that its fuse contacts point towards the connector. If the connector is being or has been plugged into the fuse box along a plugging direction, contacting of the fuse contact is effected at the contact surface. The structure of the housing assembly ensures sufficient contact overlap, as already explained.

The subject matter herein can be further improved by the following embodiments which are advantageous by themselves and which may be combined with one another arbitrarily.

According to one possible embodiment, the cubature of the access opening can represent an enveloping body for at least part of the abutment surface of the fuse body. The fuse body can then be received in the access opening with a precise fit. The enveloping body is preferably configured to be cuboid-shaped in order to obtain a simple geometry. For example, the access opening is surrounded by a rectangular outer edge and sized such that the abutment surface of the fuse body can be plugged at least sectionally behind the outer edge of the access opening.

The depth of the access opening preferably corresponds to the material thickness of the surrounding housing wall. The access opening therefore opens directly into the module chamber. The depth of the access opening is in the plugging direction measured from the outer edge of the access opening. The length and width of the access opening extend perpendicular to the depth, wherein the length and width are also perpendicular to each other.

The plug fuse typically comprises two fuse contacts that protrude from the abutment surface of the fuse body and are lined up parallel to the length of the access opening. The two fuse contacts can be connected, for example, by a fusible conductor that extends through the fuse body. One of the two fuse contacts is used to be plugged to the contact element of the connector through the access opening and the insertion opening. The other fuse contact is in permanent contact with an electrical conductor of the fuse box and is not accessible to the connector. According to a further possible embodiment, it is then sufficient to size the access opening such that at least half of the abutment surface of the fuse body can be inserted into the access opening. The abutment surface of the fuse body is typically planar.

The plug fuse can be a blade fuse for the automotive sector, for example in accordance with the ISO 8820-3, ISO 8820-10, SAE J1284 or SAE J2077 standards. This include, for example, so-called ATO fuses, ATOF fuses, Maxi fuses, Maxi+ fuses, and Mini fuses.

The access opening can be sized such that the abutment surface of the fuse body of the largest plug fuse in accordance with the ISO 8820-3, ISO 8820-10, SAE J1284 or SAE J2077 standard can be inserted. In particular, the width of the access opening can be greater than the largest width of the abutment surface of the fuse body of the largest plug fuse in accordance with the ISO 8820-3, ISO 8820-10, SAE J1284 or SAE J2077 standard. Consequently, all smaller fuse bodies according to the relevant standards can likewise be inserted into the access opening in this embodiment.

Of course, the access opening can also be smaller than the abutment surface of the fuse body of the largest plug fuse according to the ISO 8820-3, ISO 8820-10, SAE J1284 or SAE J2077 standard. In this embodiment, the access opening is then sized such that the abutment surface of the fuse body of the plug fuse according to the ISO 8820-3, ISO 8820-10, SAE J1284 or SAE J2077 standard can be inserted, the fuse contacts of which are shorter by more than the extension length of the material thickness of the housing wall than the fuse contacts of the largest plug fuse according to the ISO 8820-3, ISO 8820-10, SAE J1284 or SAE J2077 standard.

According to a further possible embodiment, the inner housing can serve as a contact holder. In other words, the inner housing receives the contact element in its interior, wherein the insertion opening leads into the interior. The insertion opening can be a slot that is configured to be complementary to the fuse contact and passes through a module wall of the inner housing. Optionally, an outer contour of the fuse contact corresponds at least sectionally to an inner contour of the insertion opening. Furthermore, an outer contour of the fuse body corresponds at least sectionally to an inner contour of the access opening. The contours correspond to one another if their width, radius, cubature, and/or cross section are the same, including a deviation of +/−10%.

The inner housing and the contact element together form a contact module. The inner housing therefore at the same time represents a module housing. The surrounding housing in turn in the form of an outer housing or plug housing functions as a module holder for the contact module. For this purpose, the inner housing is arranged in the module chamber of the surrounding housing. As a result, the housing assembly can be double-walled at least sectionally.

This double-walling arises in particular where the inner housing abuts against the housing wall. For example, the inner housing can rest on the base wall of the surrounding housing. The surrounding housing then supports the inner housing. Elsewhere, the inner housing can abut laterally against one or more side walls of the surrounding housing. The housing wall with the access opening runs at least sectionally parallel to the module wall with the insertion opening. In the region of the access opening, however, the housing assembly is only single-walled due to the module wall.

According to an embodiment that is easy to manufacture, the access opening can be formed by a recess, cutout or notch in the housing wall. In particular, the access opening can be framed by three mutually perpendicular adjacent edges of the housing wall and can be free, open, or recessed at a fourth edge. In other words, the fourth edge is offset, in particular countersunk, in the plugging direction with respect to the other three edges. The abutment surface of the fuse body can abut against this fourth edge, while it faces away from the other three edges. Furthermore, the abutment surface of the fuse body can abut in a flat manner against the inner housing, in particular against the module wall, so that sufficient stability is ensured.

The surrounding housing preferably comprises an assembly opening through which the inner housing can be inserted into the module chamber. Optionally, the assembly opening can be covered by way of a housing cover. Optionally, the inner housing can be inserted only through the assembly opening and does not fit through the access opening. From the perspective of the inner housing, the access opening is merely a window.

Like the access opening, the assembly opening can open directly into the module chamber. Furthermore, the assembly opening is preferably located on the other side of the access opening at the surrounding housing. In other words, the assembly opening and the access opening are disposed opposite each other with respect to the module chamber. Consequently, the inner housing can be inserted with the insertion opening ahead through the assembly opening into the module chamber so that the insertion opening is aligned with the access opening. In particular, the insertion opening and access opening are then aligned in the plugging direction. Optionally, the insertion opening can be coaxial with the access opening, wherein an axis that runs through the center of the insertion opening and the center of the access opening is preferably parallel to the plugging direction.

Both the alignment and the coaxiality of the access opening and insertion opening make it easier for the fuse contacts to be plugged. This is made even easier if the contact surface of the contact element already mentioned surrounds a contact reception region at least sectionally, wherein the contact reception region is aligned with the insertion opening, in particular in the plugging direction. The contact element can be configured, for example, as a contact sleeve, clamp, or fork.

Depending on the case of application, the housing assembly can comprise multiple inner housings. In other words, the housing assembly can comprise the inner housing and at least one further inner housing. The housing assembly therefore has at least one inner housing.

A respective contact element can be received in each inner housing. The electrical connector then comprises several contact modules and the fuse device of course also has several plug fuses. Advantageously, several circuits are connectable to their plug fuses at the same time.

The surrounding housing can comprise a module chamber for each inner housing. Alternatively, some or all of the inner housings can share a common module chamber to save installation space. In any case, the surrounding housing comprises at least one module chamber. Each module chamber can there provide one or more module spaces.

The housing assembly can be part of a set that comprise more inner housings than there are module spaces in the surrounding housing. The inner housings of the set can differ from one another in terms of the shape, size, position, and/or number of insertion openings and receivable contact elements. They offer a choice when fitting the connector with contact modules. In other words, the module spaces in the surrounding housing are selectively fitted with only the inner housings that are suitable for the respective application, while the unsuitable inner housings of the set are not used and remain. Optionally, the remaining inner housings of the set can be used in another set so that no waste is generated.

Conversely, the surrounding housing can also comprise more module spaces than the number of existing inner housings. The unoccupied module spaces can be subsequently populated further along the value chain.

According to a further possible embodiment, the surrounding housing can comprise at least one access opening for each module chamber. Alternatively, one or more common “cross-chamber” access openings can also be provided. The access openings are preferably all arranged on one side of the surrounding housing and point in particular in the plugging direction. This enables several circuits to be connected to their plug fuses at the same time with a single plugging motion.

Depending on the number of plug fuses, the surrounding housing can comprise an even or odd number of access openings. The access openings are preferably arranged in a row that extends, for example, perpendicular to the plugging direction. The aforementioned recess of each access opening can be disposed on the same side as the recesses of the other access openings of the row. If there is an even number of access openings, it is also possible to arrange the access openings in two rows parallel to each other. The access openings of the two rows then have their respective recesses on different, in particular oppositely disposed sides of the surrounding housing.

If required, the access openings can be configured to receive fuse bodies of different predefined sizes. For example, each access opening can be configured to receive a different fuse body in accordance with the ISO 8820-3, ISO 8820-10, SAE J1284 or SAE J2077 standard. This means that several standards can be met with one housing assembly.

Any references to norms and standards (e.g. ISO norms) in the present application refer to the version of the corresponding norm or standard applicable at the time of filing.

### BRIEF DESCRIPTION OF THE DRAWINGS

The invention shall be explained hereafter in more detail with reference to the drawings on the basis of several embodiments, the different features of which may be combined with one another as required in accordance with the above observations, where:

FIG. 1 is a schematic perspective illustration of a connector according to an exemplary embodiment in a fuse box;

FIG. 2 is a further schematic perspective illustration of the connector and the fuse box from FIG. 1;

FIG. 3 is a schematic perspective illustration of a housing assembly according to an exemplary embodiment;

FIG. 4 is a schematic perspective detailed view of the connector from FIG. 1 with plug fuses inserted; and

FIG. 5 is a schematic sectional illustration through section plane V from FIG. 4.

### DETAILED DESCRIPTION OF THE INVENTION

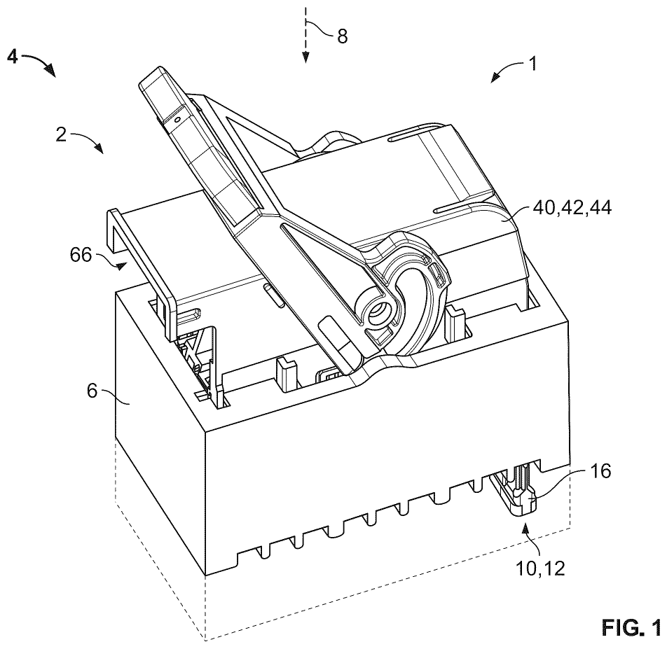

With reference to FIGS. 1 to 5, the schematic structure of a housing assembly 1, an electrical connector 2, and a fuse device 4 shall be explained hereafter.

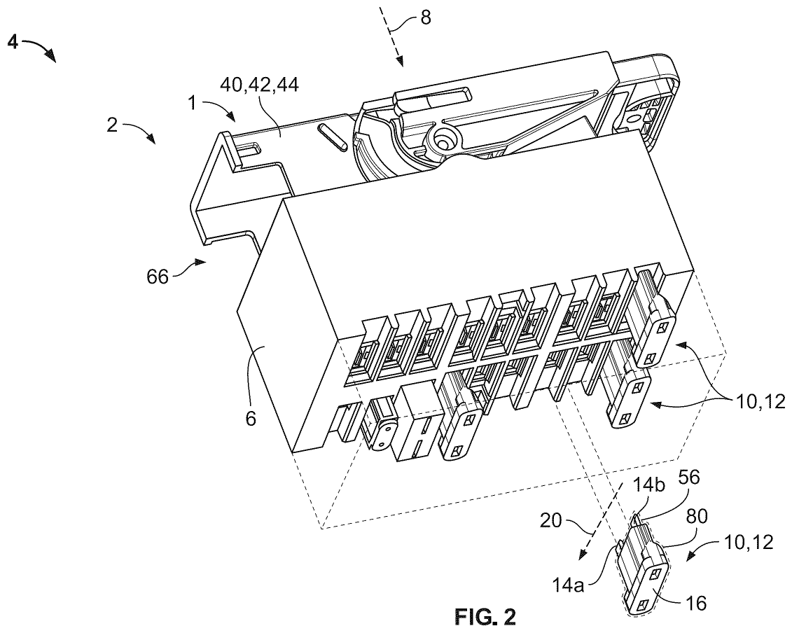

FIG. 1 shows an exemplary embodiment of connector 2 according to an exemplary embodiment which is configured to be pluggable to a fuse box 6 along a plugging direction 8. One or more plug fuses 10 are provided in fuse box 6 (see FIG. 2). Connector 2 together with fuse box 6 and plug fuses 10 form fuse device 4. Connector 2 is connectable to plug fuses 10, as shall be explained in more detail below.

In the exemplary embodiments shown, plug fuses 10 are shown as blade fuses 12 for the automotive sector. In particular, they can be blade fuses 12 according to the ISO 8820-3, ISO 8820-10, SAE J1284 or SAE J2077 standards. For example, they can be commercially available ATO fuses, ATOF fuses, Maxi fuses, Maxi+ fuses, or Mini fuses. Of course, the concept can also be applied to other plug fuses following other standards or types.

Plug fuses 10 serve to protect circuits (not shown) against faulty currents and/or overcurrents. To do this, plug fuses 10 must be integrated into the respective circuit in an electrically conductive manner. For this purpose, each plug fuse 10 comprises at least one fuse contact 14, for example, two fuse contacts 14a, 14b (see FIG. 2). In addition, each plug fuse 10 comprises a fuse body 16 with an abutment surface 18.

Fuse contacts 14, 14a, 14b protrude from abutment surface 18 and are preferably aligned parallel to one another. Optionally, fuse contacts 14, 14a, 14b are arranged next to one another in a row along a line-up direction 20. Furthermore, fuse contacts 14, 14a, 14b are connected, for example, by a fusible conductor (not shown) that extends through fuse body 16.

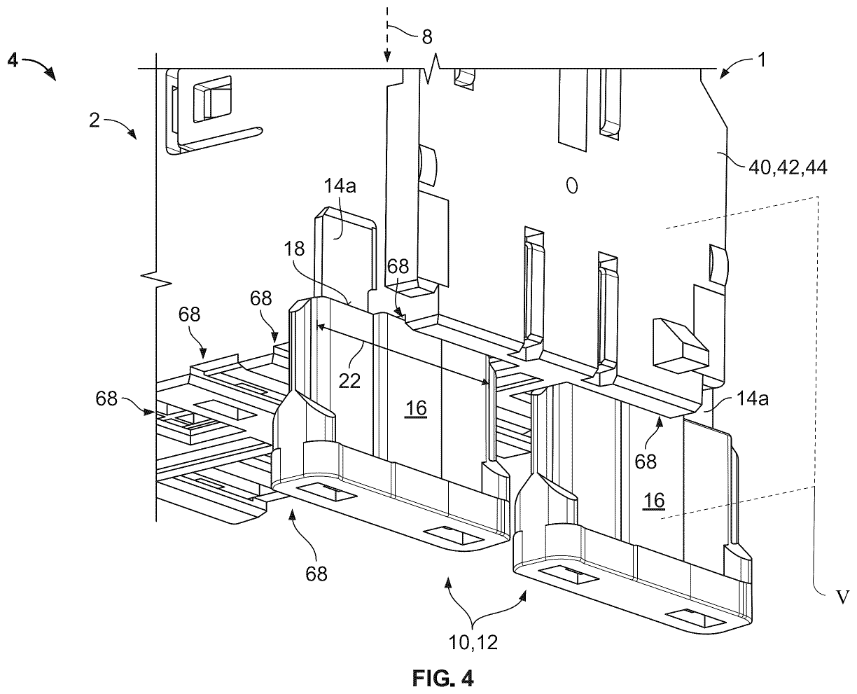

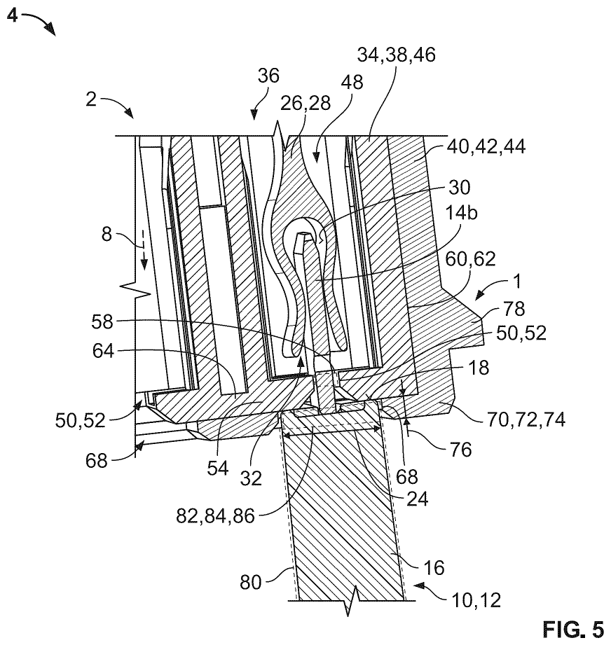

The respective plug fuse 10 itself as well as fuse contacts 14, 14a, 14b, fuse body 16 and abutment surface 18 have a predefined size. The size of plug fuse 10, fuse contacts 14, 14a, 14b, fuse body 16, and abutment surface 18 can be defined by their dimensions or their external size, respectively. The dimension of abutment surface 18 arises from its length 22 (see FIG. 4) and width 24 (see FIG. 5). Length 22 is measured parallel to abutment surface 18 and along alignment direction 20 of fuse contacts 14, 14a, 14b. Width 24 is also measured parallel to abutment surface 18 and perpendicular to length 22.

One of two fuse contacts 14a is in permanent contact with an electrical conductor (not shown) of fuse box 6 and is not accessible to connector 2. The other fuse contact 14b is intended to be connected to connector 2.

Connector 2 is part of the circuit to be protected and comprises a contact element 26 for each plug fuse 10 (see FIG. 5). Contact element 26 can be configured, for example, as a contact sleeve, clamp, or fork 28. Contact element 26 comprises a contact surface 30 for electrically contacting fuse contact 14b of plug fuse 10. Contact surface 30 surrounds at least sectionally a contact reception region 32 in which the contact is established. For this purpose, fuse contact 14b must be plugged into contact reception region 32. Once this happens, plug fuse 10 is integrated in an electrically conductively manner into the respective circuit.

Each contact element 26 is received in a contact holder 34. Contact element 26 and contact holder 34 together form a contact module 36. Contact holder 34 then functions as a module housing 38.

Fuse box 6 can be a fuse block, panel, and/or holder. Plug fuses 10 are positioned in fuse box 6 in such a way that their fuse contacts 14a, 14b point towards connector 2. If connector 2 is being or has been plugged into fuse box 6 along a plugging direction 8, contacting respective fuse contact 14b is effected at the associated contact surface 30.

Depending on the case of application, plug fuses 10 can be present in different numbers and at different positions in fuse box 6. Furthermore, there can be size differences among plug fuses 10 due to application-specific configurations. This means that a wide variety of combinations of plug fuses 10 can arise in fuse box 6.

In order to be able to represent this diversity, connector 2 has a modular configuration and can therefore be flexibly configured. For this purpose, connector 2 can comprise several exchangeable contact modules 36 which, in terms of contact element 26 and module housing 38, are each configured for different or identical plug fuses 10.

Depending on which plug fuses 10 are present in fuse box 6, connector 2 can be fitted with appropriate contact modules 36. For this purpose, connector 2 furthermore comprises a plug housing 40 in which contact modules 36 are held. Plug housing 40 therefore serves as a module holder 42.

Due to the relative spatial arrangement, plug housing 40 is henceforth referred to as surrounding housing 44 and module housing 38 is henceforth referred to as inner housing 46. Surrounding housing 44 and inner housing 46 form modular housing assembly 1.

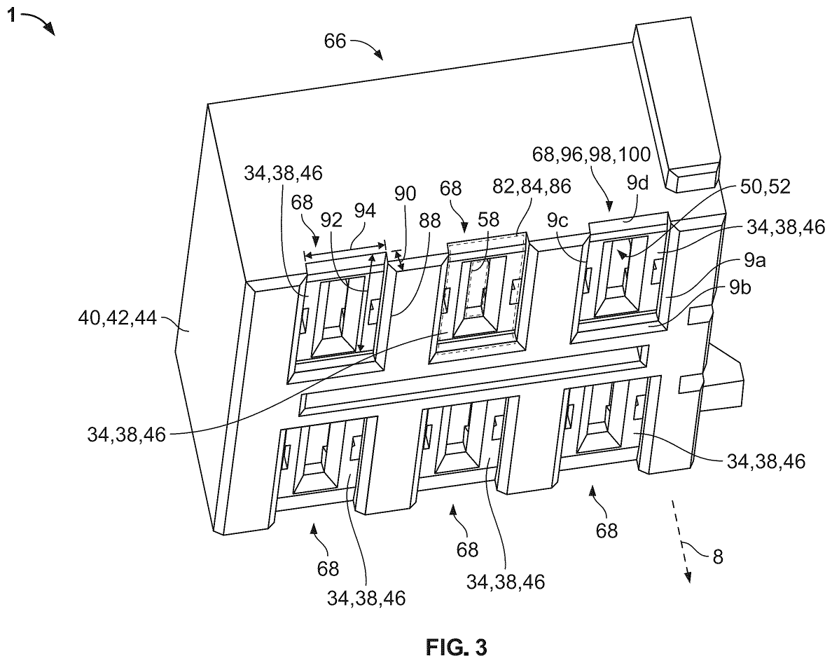

As already mentioned, the respective contact element 26 is received in inner housing 46, which serves as contact holder 34, in particular in interior 48 of inner housing 46. Inner housing 46 also comprises an insertion opening 50 through which fuse contact 14b is pluggable. Insertion opening 50 leads to interior 48 of inner housing 46. Contact reception region 32 of contact element 26 already mentioned is aligned with insertion opening 50, in particular in plugging direction 8. Insertion opening 50 can be a slot 52 that is configured to be complementary to fuse contact 14b and passes through a module wall 54 of inner housing 46 (see FIG. 3). Optionally, an outer contour 56 of fuse contact 14b corresponds at least sectionally to an inner contour 58 of insertion opening 50.

For each inner housing 46, surrounding housing 44 comprises a module chamber 60 in which inner housing 46 can be arranged. In FIG. 3, six separate inner housings 46 are arranged in a module chamber 60 of surrounding housing 44. Alternatively, some or all of inner housings 46 can share a common module chamber (see FIG. 5). In other words, each module chamber 60 offers one or more module spaces 62 for one inner housing 46 each, possibly with contact element 26 as contact module 36. Optionally, several inner housings 46 are connectable by way of material bridges 64.

In addition, surrounding housing 44 preferably comprises an assembly opening 66 through which the respective inner housing 46 can be inserted into its associated module chamber 60. Assembly opening 66 opens directly into module chamber 60 or module chambers 60, respectively. Optionally, assembly opening 66 can be covered by way of a housing cover (not shown).

For each module chamber 60, surrounding housing 44 can comprise at least one access opening 68 that passes through a housing wall 70 of surrounding housing 44. Housing wall 70 can be an outer wall 72, in particular a base wall 74 of surrounding housing 44.

Access openings 68 are optionally all arranged on one side of surrounding housing 44 and point in particular in plugging direction 8 (see FIG. 3). Preferably, the respective inner housing 46 can only be inserted through assembly opening 66 and does not fit through its associated access opening 68. According to an alternative embodiment, not shown, one or more common, “cross-chamber” access openings can also be provided.

Respective access opening 68 is primarily there to be able to plug fuse contact 14b into insertion opening 50 of inner housing 46. For this purpose, insertion opening 50 and access opening 68 are aligned in plugging direction 8 (see FIG. 3). Housing wall 70 with access opening 68 can run at least sectionally parallel to module wall 54 with insertion opening 50. In particular, insertion opening 50 and access opening 68 are coaxial, wherein an axis that runs through the center of insertion opening 50 and the center of access opening 68 is parallel to plugging direction 8. As a result, contact surface 30 arranged in the inner housing is easily accessible to fuse contact 14b.

In addition, the respective access opening 68 is sized such that fuse body 16 can be inserted completely into access opening 68 in plugging direction 8 along material thickness 76 of housing wall 70. Complete insertion is given when fuse body 16 enters access opening 68 over the entire extension length of material thickness 76 of housing wall 70 (see FIG. 5).

As can also be seen from FIG. 5, the respective inner housing 46 can abut against housing wall 70 of surrounding housing 44. For example, inner housing 46 can rest on base wall 74 of surrounding housing 44. In addition, inner housing 46 can abut laterally against one or more side walls 78 of surrounding housing 44. As a result, housing assembly 1 is double-walled at least sectionally. In the region of access opening 68, however, housing assembly 1 is only single-walled due to the remaining module wall 54.

Without access opening 68, plugged fuse contact 14b would have to completely penetrate the double wall of surrounding housing 44 and inner housing 46 before it reaches contact element 26. This would result in fuse contact 14b that comes from the outside not sufficiently reaching inner contact element 26.

This is the advantage of access opening 68 which is configured to receive at least in part fuse body 16 of the associated plug fuse 10. By receiving fuse body 16 in access opening 68 along the entire material thickness 76 of housing wall 70, plug fuse 10 can be pushed deeper into housing assembly 1, since only module wall 54 of inner housing 46 has to be penetrated. This enables plugged fuse contact 14b to better reach contact element. In particular, the contact overlap between fuse contact 14b and contact element 26 can be increased, which ensures reliable contact.

An outer contour 80 of fuse body 16 can correspond at least sectionally to an inner contour 82 of access opening 68. In particular, the cubature 84 of access opening 68 can represent an enveloping body 86 for at least part of abutment surface 18 of fuse body 16. Enveloping body 86 is preferably configured to be cuboid-shaped. For example, access opening 68 is surrounded by a rectangular outer edge 88 and is sized such that abutment surface 18 of fuse body 16 can be plugged at least in part behind this outer edge 88 of access opening 68. It is then often sufficient to size access opening 68 such that at least half of abutment surface 18 of fuse body 16 can be inserted into access opening 68. Abutment surface 18 of fuse body 16 is there typically planar.

Depth 90 of the access opening 68 preferably corresponds to material thickness 76 of housing wall 70. Access opening 68 then opens directly into module chamber 60 or module chambers 60, respectively. Depth 90 of access opening 68 is measured in plugging direction 8 from outer edge 88 of access opening 68. Length 92 and width 94 of access opening 68 extend perpendicular to depth 90, where length 92 and width 94 are also perpendicular to one another. As can be seen in FIG. 2, fuse contacts 14, 14a, 14b are lined up parallel to length 92 of access opening 68.

Optionally, access opening 68 can be sized such that abutment surface 18 of fuse body 16 of the largest plug fuse 10 in accordance with the ISO 8820-3, ISO 8820-10, SAE J1284 or SAE J2077 standard can be inserted. In particular, width 94 of access opening 68 can be greater than the largest width 24 of abutment surface 18 of fuse body 16 of the largest plug fuse 10 in accordance with the ISO 8820-3, ISO 8820-10, SAE J1284 or SAE J2077 standard. Consequently, all smaller fuse bodies 16 according to the relevant standards can likewise be inserted into access opening 68 in this embodiment.

As can be seen from FIG. 3, the respective access opening 68 can be formed by a recess 96, cutout 98, or notch 100 in housing wall 70. In particular, access opening 68 can be framed by three mutually perpendicular adjacent edges 9a, 9b, 9c of housing wall 70 and can be respectively free, open, or recessed at a fourth edge 9d. In other words, fourth edge 9d is offset, in particular countersunk, in plugging direction 8 in relation to the three other edges 9a, 9b, 9c. Abutment surface 18 of fuse body 16 can abut against this fourth edge 9d, while abutment surface 18 faces away from the three other edges 9a, 9b, 9c (see FIG. 4). Furthermore, abutment surface 18 of fuse body 16 can abut in a flat manner against inner housing 46, in particular against module wall 54 (see FIG. 5).

Assembly opening 66 can be disposed on the side of surrounding housing 44 (see FIG. 2). Alternatively, assembly opening 66 can be arranged on the other side of access opening 68 on surrounding housing 44. In other words, assembly opening 66 and access opening 68 can be disposed opposite one another with respect to module chambers 60 (see FIG. 3). Consequently, respective inner housing 46 can be inserted with insertion opening 50 ahead through assembly opening 66 into associated module chamber 60 so that insertion opening 50 is aligned with access opening 68. Contact reception region 32 of contact element 26 already mentioned is then likewise aligned with access opening 68, in particular in plugging direction 8 (see FIG. 5).

As already described, housing assembly 1 comprises one or more inner housings 46. Housing assembly 1 can be in particular part of a set that comprises more inner housings 46 than there are module spaces 62 present in surrounding housing 44. Inner housings 46 of the set can differ from one another in terms of shape, size, position, and/or number of insertion openings 50 as well as contact elements 14 that can be received. Module spaces 62 in surrounding housing 44 can be selectively fitted with inner housings 46 that are suitable for the respective application, while unsuitable inner housings 46 of the set are not used and remain.

Conversely, surrounding housing 44 can also have more module spaces 62 than the number of existing inner housings 46. Unoccupied module spaces 62 can be subsequently fitted further along the value chain.

Surrounding housing 44 shown in FIG. 3 has six access openings 68 that are arranged in two parallel rows. The two rows extend, for example, perpendicular to plugging direction 8. The aforementioned recess 96 of each access opening 68 can be disposed on the same side as recesses 96 of other access openings 68 of the same row.

When connector 2 is being or has been plugged into fuse box 6, fuse contacts 14b of the respective plug fuses 10 protrude into housing assembly 1. In particular, fuse contacts 14b protrude through access opening 68 of surrounding housing 44 and are plugged into insertion opening 50 of inner housing 46. In other words, fuse contacts 14b pass through access opening 68 and insertion opening 50 in order to be plugged to associated contact element 26 of connector 2.

Fuse body 16 is received at least in part in access opening 68. Meanwhile, the other fuse contacts 14a remain outside housing assembly 1. In particular, plug fuses 10 each protrude on opposite sides of surrounding housing 44 (see FIG. 4).

According to an alternative embodiment not shown, an odd number of access openings 68 can also be provided at surrounding housing 44. Access openings 68 can then be arranged in a row that extends, for example, perpendicular to plugging direction 8.

If necessary, access openings 68 can be configured to receive fuse bodies 16 of different predefined sizes. For example, each access opening 68 can be configured to receive a different fuse body 16 in accordance with the ISO 8820-3, ISO 8820-10, SAE J1284 or SAE J2077 standard.

Any references to norms and standards (e.g. ISO standards) in this application refer to the version of the relevant norm or standard applicable at the time of filing.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. Modular housing assembly for an electrical connector connectable to a plug fuse of a predefined size with fuse contacts protruding from an abutment surface of a fuse body, the modular housing assembly comprising:
an inner housing configured to receive a contact element which can be connected to said plug fuse, wherein said inner housing comprises an insertion opening through which one of said fuse contacts of said plug fuse can be plugged; and
a surrounding housing including a module chamber receiving said inner housing, said surrounding housing including an access opening leading into said module chamber, wherein said access opening passes through a housing wall of said surrounding housing and is sized such that said fuse body of said plug fuse can be inserted completely into said access opening along the material thickness of said housing wall.

2. Modular housing assembly according to claim 1, wherein a cubature of said access opening represents an enveloping body for at least part of said abutment surface of said fuse body.

3. Modular housing assembly according to claim 1, wherein said access opening is sized such that said abutment surface of said fuse body of the largest plug fuse according to the ISO 8820-3, ISO 8820-10, SAE J1284 or SAE J2077 standard can be inserted.

4. Modular housing assembly according to claim 3, wherein a width of said access opening is greater than a largest width of said abutment surface of said fuse body of said largest plug fuse according to the ISO 8820-3, ISO 8820-10, SAE J1284 or SAE J2077 standard.

5. Modular housing assembly according to claim 1, wherein said inner housing is arranged in said module chamber of said surrounding housing so that said housing assembly is double-walled at least sectionally.

6. Modular housing assembly according to claim 1, wherein said inner housing abuts against said housing wall.

7. Modular housing assembly according to claim 1, wherein said access opening is formed by a recess in said housing wall.

8. Modular housing assembly according to claim 1, wherein said insertion opening is aligned with said access opening.

9. Modular housing assembly according to claim 1, wherein said insertion opening is coaxial with said access opening.

10. Modular housing assembly according to claim 1, wherein said inner housing is one of multiple inner housings, said surrounding housing comprises a module chamber for each of said multiple inner housings.

11. Housing assembly according to claim 10, wherein said surrounding housing comprises at least one access opening for each module chamber and said access openings are all arranged on one side of said surrounding housing.

12. Housing assembly according to claim 11, wherein said surrounding housing comprises an even or odd number of access openings arranged in a row.

13. Modular housing assembly according to claim 11, wherein said access openings are configured to receive fuse bodies of different predefined sizes.

14. Electrical connector connectable to a plug fuse of a predefined size with fuse contacts protruding from an abutment surface of a fuse body, said electrical connector comprising:
a modular housing assembly including a surrounding housing and an inner housing received in said surrounding housing, said inner housing including an insertion opening through which one of said fuse contacts of said plug fuse can be plugged, said surrounding housing including a module chamber receiving said inner housing, said surrounding housing including an access opening leading into said module chamber, wherein said access opening passes through a housing wall of said surrounding housing and is sized such that said fuse body of said plug fuse can be inserted completely into said access opening along the material thickness of said housing wall; and
a contact element received in said inner housing, said contact element including a contact surface for electrically contacting said plug fuse, wherein said contact surface is arranged in said inner housing and is accessible to one of said fuse contacts of said plug fuse through said insertion opening.

15. Connector according to claim 14, wherein said contact surface surrounds a contact reception region at least sectionally and said contact reception region is aligned with said insertion opening.

16. Connector according to claim 14, wherein a cubature of said access opening represents an enveloping body for at least part of said abutment surface of said fuse body.

17. Connector according to claim 14, wherein said access opening is sized such that said abutment surface of said fuse body of the largest plug fuse according to the ISO 8820-3, ISO 8820-10, SAE J1284 or SAE J2077 standard can be inserted.

18. Connector according to claim 14, wherein said inner housing is arranged in said module chamber of said surrounding housing so that said housing assembly is double-walled at least sectionally.

19. Connector according to claim 14, wherein said insertion opening is aligned with said access opening.

20. Connector according to claim 14, wherein said inner housing is one of multiple inner housings, said surrounding housing comprises a module chamber for each of said multiple inner housings, said surrounding housing comprises at least one access opening for each module chamber and said access openings are all arranged on one side of said surrounding housing.
